(19) United States
(12) Patent Application Publication
(10) Pub. No.: US 2015/0146563 A1
(43) Pub. Date: May 28, 2015

(54) METHOD OF SENSING EXCESSIVE BANDWIDTH USAGE

(71) Applicant: ELECTRONICS AND TELECOMMUNICATIONS RESEARCH INSTITUTE, Daejeon (KR)

(72) Inventors: Young Min KIM, Daejeon (KR); Kyoung Soon KANG, Daejeon (KR); Hea Sook PARK, Daejeon (KR); Byung Jun AHN, Daejeon (KR); Boo Geum JUNG, Daejeon (KR)

(21) Appl. No.: 14/547,490

(22) Filed: Nov. 19, 2014

(30) Foreign Application Priority Data
Nov. 25, 2013 (KR) 10-2013-0143797

(51) Int. Cl. H04L 12/26

(52) U.S. Cl. CPC H04L 43/0882; H04L 43/062
USPC 370/252

(57) ABSTRACT

A method of sensing an excessive bandwidth usage includes acquiring an information set of a network bandwidth usage, applying a plurality of excessive bandwidth use sensing techniques to the acquired information set, determining an excessive bandwidth usage, and then limiting the determined excessive bandwidth usage. Accordingly, the network bandwidth may be uniformly secured and provided by limiting the bandwidth usage that uses the excessive network band.

### CLAIM FOR PRIORITY

This application claims priority to Korean Patent Application No. 10-2013-0143797 filed on Nov. 25, 2013 in the Korean Intellectual Property Office (KIPO), the entire contents of which are hereby incorporated by reference.

### BACKGROUND

1. Technical Field

Example embodiments of the present invention relate in general to a method of operating network bandwidth, and more specifically, to a method of sensing an excessive bandwidth usage.

2. Related Art

With the development of the Internet, multimedia services, such as peer-to-peer (P2P), Internet protocol (IP) TV, and the like, which require a large capacity of bandwidth and a low delay, are increasingly introduced. Users require that such services are secured to have high quality. Accordingly, network providers are searching for solutions to maximize network use efficiency in order to satisfy the requirements of the users.

To maximize network use efficiency, users use various services while sharing limited band resources that are provided by network providers. The resource sharing method increases the network use efficiency significantly, but causes an irrational situation in which when a few users consume most of the bandwidth, other users cannot secure the service.

FIG. 1 is a graph showing a subscribed-based bandwidth use status.

Referring to FIG. 1, most subscribers use only some of the bandwidth (40% of the subscribers use 3.8% of the entire bandwidth), and a few subscribers use most of the bandwidth (5% of the subscribers use 45.3% of the entire bandwidth.)

As described above, when congestion occurs, a router generally performs a policy for discarding all incoming packets at random. When the subscriber uses an excessive bandwidth in excess of an allocated bandwidth, it is reasonable for the subscriber to experience service quality degradation. However, as shown in FIG. 1, 40% of subscribers who use only 3.8% of the entire bandwidth also unreasonably experience service quality degradation although the subscribers hardly use an allocated bandwidth.

To solve the unreasonable difficulty, a uniform bandwidth distribution technology in which bandwidth is uniformly distributed to all subscribers has been developed when congestion occurs. However, the uniform bandwidth distribution technology cannot completely solve the above problem.

FIG. 2 is a graph showing a subscribed-based use bandwidth when the uniform bandwidth distribution policy is applied.

First, the uniform bandwidth distribution technology is a technology that uniformly allocates bandwidth to subscribers, which allocates bandwidth corresponding to a subscriber ratio. That is, as shown in FIG. 2, when 5% of the subscribers use 45.3% of the entire bandwidth, only 5% (that is the subscriber ratio) of the entire bandwidth are allocated, and 40.3% are discarded.

In addition, when 40% of the subscribers use 3.8% of the entire bandwidth, 40% (that is the subscriber ratio) of the entire bandwidth are allocated, but 3.8% are actually used and the remaining 36.2% are wasted with no use.

As described above, a conventional technology that is used to maximize the network use efficiency is inefficient and provides unreasonable bandwidth use to subscribers who use bandwidth.

### SUMMARY

Accordingly, example embodiments of the present invention are provided to substantially obviate one or more problems due to limitations and disadvantages of the related art.

Example embodiments of the present invention provide an excessive bandwidth usage sensing method that may accurately and efficiently sense an excessive bandwidth usage for each user and limit the sensed excessive bandwidth usage.

In some example embodiments, a method of sensing an excessive bandwidth usage includes acquiring an information set of a bandwidth usage; applying a plurality of excessive bandwidth use sensing techniques to the acquired information set; and determining a presence or absence of a final excessive bandwidth usage based on a result value of each of the plurality of excessive bandwidth use sensing techniques.

The acquiring of an information set of a bandwidth usage may include acquiring a byte usage information set of the bandwidth usage; and acquiring a subscriber-based byte usage from the acquired byte usage information set.

The applying of a plurality of excessive bandwidth use sensing techniques may include sequentially arranging the acquired information set in order of size, sensing the excessive bandwidth usage based on a median value and a deviation value of the arranged information set to calculate a first result value using a result of the sensing, and comparing the calculated first result value with a predetermined comparison reference value to calculate a first comparison result value.

The comparison reference value may be determined differently depending on a range for determining the bandwidth usage as the excessive bandwidth usage.

The applying of a plurality of excessive bandwidth use sensing techniques may include sequentially arranging the acquired information set in order of size, dividing the arranged information set into quartiles to calculate a comparison range for sensing the excessive bandwidth usage, and calculating a second result value according to whether the bandwidth usage is within or outside the calculated comparison range.

The calculating of a comparison range for sensing the excessive bandwidth usage may include determining an upper limit and a lower limit of the comparison range based on a first quartile and a third quartile among the quartiles

The method may further include determining the bandwidth usage as the excessive bandwidth usage when the bandwidth usage is greater than or equal to the upper limit of the comparison range or less than or equal to the lower limit of the comparison range.

The determining of a presence or absence of a final excessive bandwidth usage may include adding result values of the plurality of excessive bandwidth use sensing techniques to calculate a final result value and comparing the calculated final result value with the predetermined threshold value to determine presence or absence of the excessive bandwidth usage.

The threshold value may be determined based on the number of the plurality of excessive bandwidth use sensing techniques.

### BRIEF DESCRIPTION OF DRAWINGS

Example embodiments of the present invention will become more apparent by describing in detail example embodiments of the present invention with reference to the accompanying drawings, in which:

FIG. 1 is a graph showing a bandwidth use status of each subscriber;

FIG. 2 is a graph showing a subscribed-based use bandwidth when the uniform bandwidth distribution policy is applied;

FIG. 3 is a flowchart illustrating a method of sensing an excessive bandwidth usage according to an embodiment of the present invention;

FIG. 4 is a conceptual view of information that is collected using the method of sensing an excessive bandwidth usage according to an embodiment of the present invention;

FIG. 5 is a conceptual view illustrating a process of applying a technique for sensing an outlier in the method of sensing an excessive bandwidth usage according to an embodiment of the present invention;

FIG. 6 is a conceptual view for describing an example of the technique for sensing an outlier shown in FIG. 5;

FIG. 7 is a conceptual view for describing in detail a process of performing the technique for sensing an outlier shown in FIG. 6; and

FIG. 8 is a block diagram illustrating a configuration of an apparatus for sensing an excessive bandwidth usage according to an embodiment of the present invention.

### DESCRIPTION OF EXAMPLE EMBODIMENTS

Since the present invention may be variously modified and have several exemplary embodiments, specific exemplary embodiments will be shown in the accompanying drawings and be described in detail in a detailed description.

However, it should be understood that the particular embodiments are not intended to limit the present disclosure to specific forms, but rather the present disclosure is meant to cover all modification, similarities, and alternatives which are included in the spirit and scope of the present disclosure.

In the following description, the technical terms are used only for explaining a specific exemplary embodiment while not limiting the present disclosure. Singular forms used herein are intended to include plural forms unless explicitly indicated otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or a combination thereof.

Unless otherwise defined, all terms (including technical and scientific terms) used herein have the same meaning as commonly understood by one of ordinary skill in the art to which this invention belongs. Terms such as terms that are generally used and in dictionaries should be construed as having meanings matched with contextual meanings in the art. In this description, unless defined clearly, terms are not ideally, excessively construed as formal meanings.

Hereinafter, exemplary embodiments of the present invention will be described in detail with reference to the accompanying drawings. Hereinafter, the same reference numerals are used for the same components in the drawings, and the repetitive description thereof will be omitted.

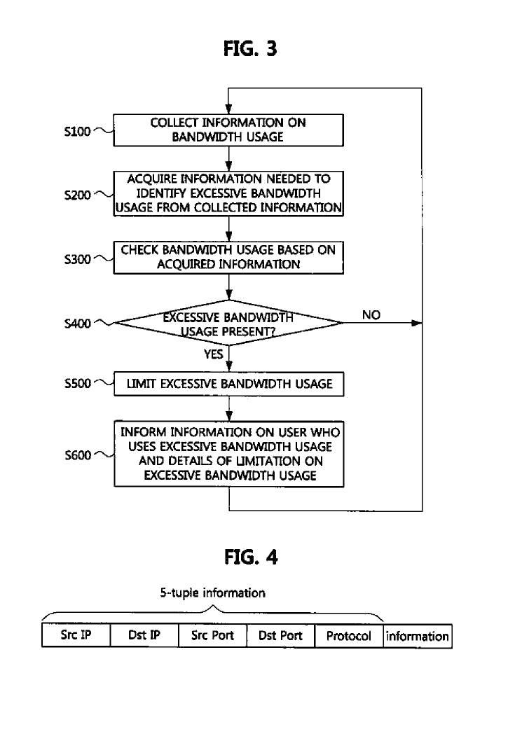

FIG. 3 is a flowchart illustrating a method of sensing an excessive bandwidth usage according to an embodiment of the present invention.

The method of sensing an excessive bandwidth usage shown in FIG. 3 may be performed by an apparatus for performing operation, administration, and maintenance (OAM) on a network.

Referring to FIG. 3, first, a resource allocation apparatus collects information on the bandwidth usage (S100). For example, when the resource allocation apparatus is implemented as a router, the information may be collected from a line card and a port interface of the router.

Subsequently, the resource allocation apparatus acquires information needed to identify the excessive bandwidth usage from the information collected in operation S100 (S200).

Here, the acquired information may include the number of subscriber-based created flows, which may be used to determine a user-based byte usage and a peer-to-peer (P2P) service availability, and the information may be used to directly determine whether an excessive bandwidth is used.

Subsequently, the resource allocation apparatus applies an outlier sensing technique to the acquired information (S300).

The resource allocation apparatus according to an embodiment of the present invention applies the outlier sensing technique to the acquired information in order to sense the excessive bandwidth usage.

Here, the outlier sensing technique is a method of identifying information having an abnormal value with reference to each information value in an information set. A result value of the outlier sensing technique may vary depending on a standardized distribution form of each piece of information in the information set. Accordingly, according to an embodiment of the present invention, by utilizing a plurality of outlier sensing techniques, a deviation between calculated result values of the outlier sensing techniques may be reduced, and thus a sensing accuracy of the excessive bandwidth usage may be enhanced.

Subsequently, the resource allocation apparatus may check a presence or absence of an excessive bandwidth usage among a network bandwidth usage (S400).

Here, the presence or absence of the excessive bandwidth usage may be checked by comparing the result value of the outlier sensing technique applied in operation S300 with a predetermined threshold. That is, the resource allocation apparatus determines that the excessive bandwidth usage is present when the result value of the outlier sensing technique is greater than the predetermined threshold.

On the other hand, when the result value of the outlier sensing technique is less than the predetermined threshold, the resource allocation apparatus determines that excessive bandwidth usage is not present.

Subsequently, when it is determined that the excessive bandwidth usage is present in operation S400, the resource allocation apparatus limits the determined excessive bandwidth usage (S500).

Here, the resource allocation apparatus may limit the excessive bandwidth usage for each flow with reference to overall 5-tuple information among information collected in operation S100 or may limit the excessive bandwidth usage for each subscriber with reference to only a source IP address (Src IP) among the 5-tuple information collected in operation S100.

In addition, the resource allocation apparatus may use a method of discarding packets for each flow and each user, either wholly or selectively, or may use a method of blocking creation of a new flow as the method of limiting the excessive bandwidth usage.

The resource allocation apparatus proceeds to operation S100 and repeatedly performs operations S100 to S600 when it is determined in operation S400 that the excessive bandwidth usage is not present.

Subsequently, the resource allocation apparatus transmits detailed information on a limitation of the excessive bandwidth usage performed in operation S500 and information on a user who uses the excessive bandwidth to an external device (S600).

Subsequently, the resource allocation apparatus proceeds to operation S100 and repeatedly performs operations S110 to S600.

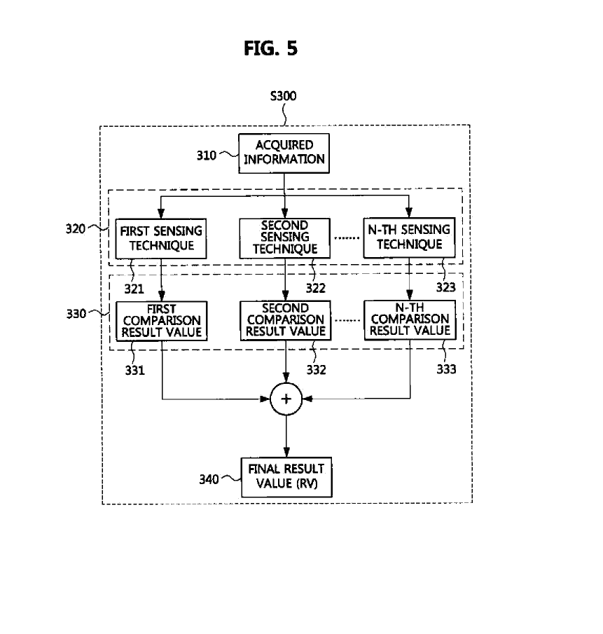

FIG. 4 is a conceptual view of information that is collected using the method of sensing an excessive bandwidth usage according to an embodiment of the present invention.

As shown in FIG. 4, the information collected in operation S100 of FIG. 3 may be configured in a general form including 5-tuple information

Here, the 5-tuple information collected by the resource allocation apparatus may include a source IP address (Src IP), a destination IP address (Dst IP), a source port (Src Port), a destination port (Dst Port), and a protocol.

The resource allocation apparatus may acquire information needed to identify the excessive bandwidth usage from among the information formed in the above format. The needed information may include at least one of a network subscriber-based byte usage and the number of subscriber-based created flows.

Furthermore, the resource allocation apparatus may acquire the needed information in order to limit the excessive bandwidth usage in the information configured in the above format. For example, the resource allocation apparatus may limit the excessive bandwidth usage for each flow with reference to overall 5-tuple information among the information configured in the above format, and may limit the excessive bandwidth usage for each subscriber with reference to only the source IP address (Src IP) among the 5-tuple information.

FIG. 5 is a conceptual view illustrating a process of applying a technique for sensing to an outlier in the method of sensing an excessive bandwidth usage according to an embodiment of the present invention.

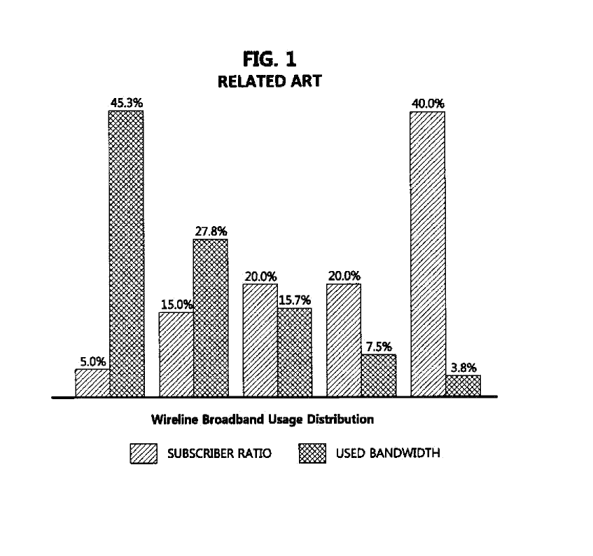

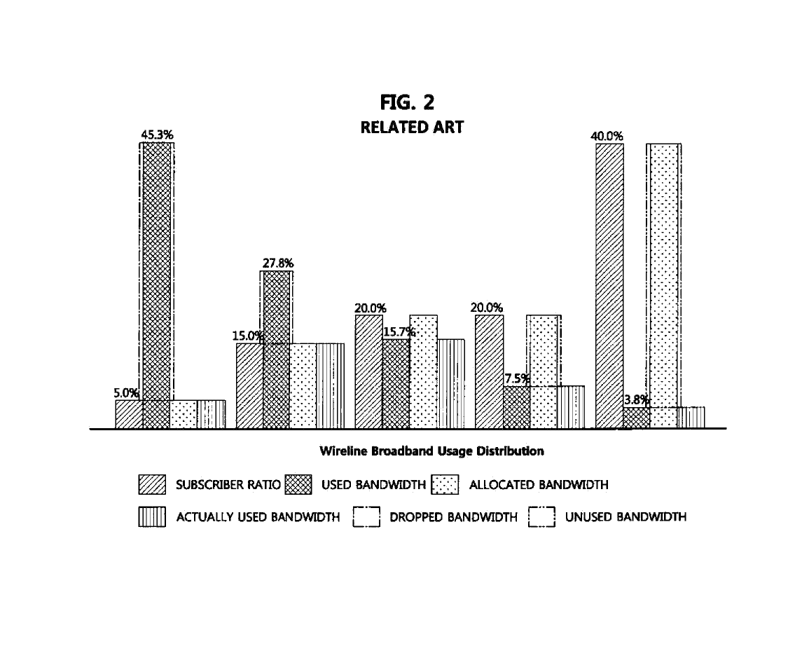

As shown in FIG. 5, first, the resource allocation apparatus may apply a plurality of outlier sensing techniques 320 to the information acquired in operation S200 of FIG. 1. That is, a first sensing technique 321, a second sensing technique 322, and an n-th sensing technique 323 may be applied to the acquired information 310.

Subsequently, the resource allocation apparatus calculates a first comparison result value 331, a second comparison result value 332, and an n-th comparison result value 333 as a result of the plurality of outlier sensing techniques 320.

Subsequently, the resource allocation apparatus adds the calculated plurality of comparison result values 330 to determine a final result value 340, and uses the determined final result value to sense the excessive bandwidth usage.

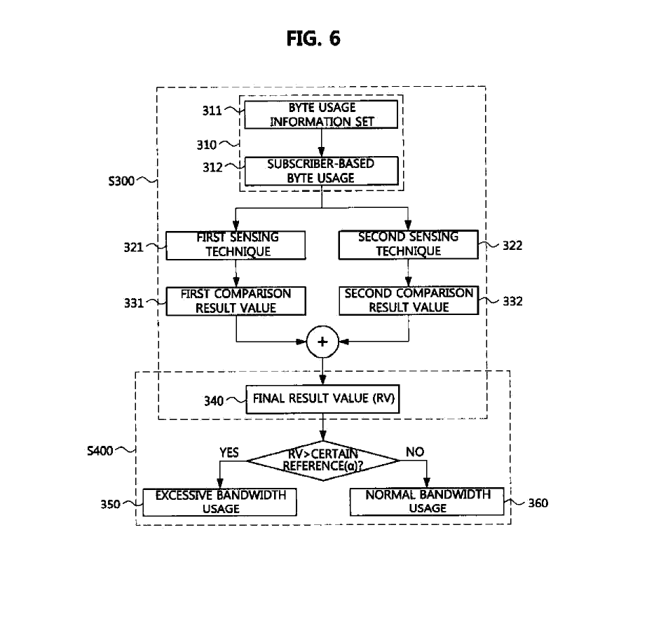

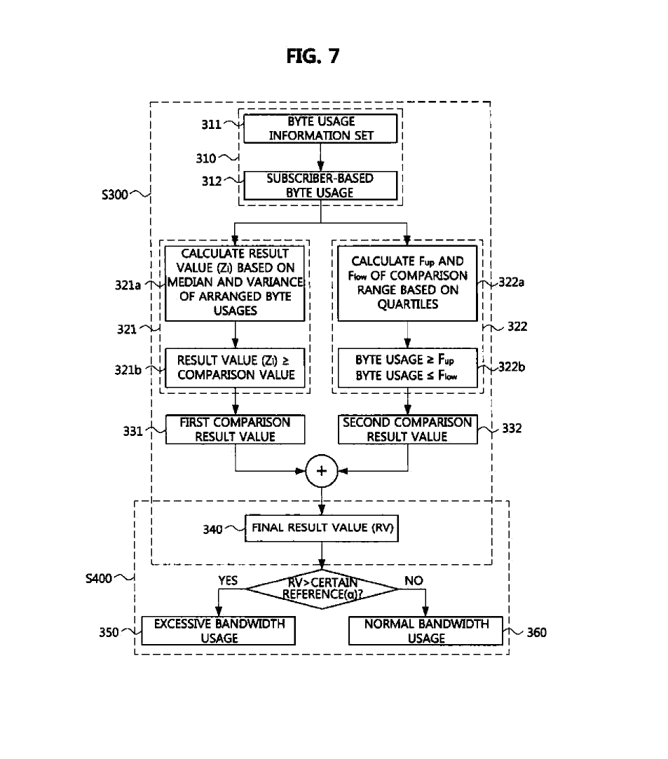

FIG. 6 is a conceptual view for describing an example of the technique for sensing an outlier shown in FIG. 5.

As shown in FIG. 6, in an embodiment of the present invention, various outlier sensing techniques including a modified z-score technique that is used to adjust a standard value, a boxplot technique using a quartile, a z-score technique using a standard value, and an adjust boxplot technique using an adjustment of the quartile may be utilized.

Referring to FIG. 6, first, the resource allocation apparatus identifies the excessive bandwidth usage from among the acquired information 310 by identifying a subscribed-based byte usage 312 in a subscriber-based byte usage information set 311.

Here, in an embodiment of the present invention, the presence or absence of the excessive bandwidth usage may be sensed based on the byte usage information set and the subscriber-based byte usage 312. However, in addition to the used byte usage information set and subscriber-based byte usage 312, the number of subscriber-based created flows or information for identifying the excessive bandwidth usage may be utilized.

Subsequently, the resource allocation apparatus applies the byte usage information set and the subscriber-based byte usage 312 to the first sensing technique 321 and the second sensing technique 322, respectively, to acquire a first comparison result value 331 and a second comparison result value 332 as respective comparison result values.

Subsequently, the resource allocation apparatus adds the acquired first comparison result value 331 and second comparison result value 332 to calculate a final result value (RV) 340, and compares the calculated final result value (RV) 340 with a predetermined certain reference a to check whether the excessive bandwidth usage 350 is present (S400). Here, the certain reference a has the same meaning as the threshold of the operation S400 of FIG. 3.

When the calculated final result value is greater than the certain value α, the resource allocation apparatus determines this situation as an excessive bandwidth usage 350.

On the other hand, when the calculated final result value is less than the certain value α, the resource allocation apparatus determines this situation as a normal bandwidth usage 360.

Here, the certain reference may be determined in consideration of the number of outlier sensing techniques that are applied together. For example, it is assumed that when the number of outlier sensing techniques that are applied together is n, the certain reference value α is set as n/2. The certain reference value being n/2 indicates that half or more of the utilized outlier sensing techniques have sensed the excessive bandwidth usage 350.

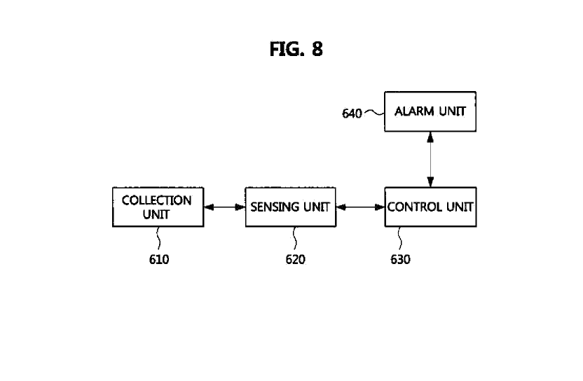

FIG. 7 is a conceptual view for describing in detail a process of performing the technique for sensing an outlier shown in FIG. 6.

As shown in FIG. 7, first, the resource allocation apparatus acquires a byte usage information set 311 with respect to a bandwidth usage of the information 310 acquired in operation S200 of FIG. 3, acquires a subscriber-based byte usage 312, arranging the acquired subscriber-based byte usage 312 in order of size, and calculating a quartile value 520 from the subscriber-based byte usage.

First, the first sensing technique 321 calculates a result value (zᵢ) (z-score) 321a for sensing the excessive bandwidth usage on the basis of a median value and a variance value of the arranged byte usage values.

Here, the first sensing technique 321 is configured to sense the byte usage as an outlier to calculate ‘1’ as the first comparison result value 331 when the calculated result value (zᵢ) (z-score) is greater than or equal to a predetermined comparison value (321b), and sense the byte usage as normal to calculate ‘0’ as the first comparison result value 331 when the calculated result value (zᵢ) (z-score) is less than the predetermined comparison value.

In addition, the second sensing technique 322 calculates a comparison range for determining the excessive bandwidth usage on the basis of the calculated quartile value. Here, an upper limit value Fᵤₚ and a lower limit value F_{low} of the comparison range are calculated on the basis of the calculated quartile value.

The quartile value includes quartile 1 (Q1), quartile 2 (Q2), and quartile 3 (Q3). Here, when the plurality of byte usages are arranged in increasing order, quartile 1 (Q1) denotes a data value corresponding to a bottom 25%, quartile 2 (Q2) denotes a data value corresponding to a median, and quartile 3 (Q3) denotes a data value corresponding to an upper 25%.

The upper limit Fᵤₚ and the lower limit F_{low} of the comparison range for determining the excessive bandwidth usage may be calculated on the basis of Equation 1 and Equation 2 below.

Fᵤₚ=Q3+1.5(Q3−Q1) [Equation 1]

F_{low}=Q1−1.5(Q3−Q1) [Equation 2]

Here, the second sensing technique 322 may be configured to compare the byte usage with the calculated upper limit value Fᵤₚ and lower limit value F_{low} to sense the byte usage as to an outlier (322b) and calculate ‘1’ as the second comparison result value 332 when the byte usage is greater than the upper limit value, and to calculate ‘0’ when the byte usage is less than the upper limit value.

In addition, the second sensing technique 322 may be configured to sense the byte usage as an outlier and calculate ‘1’ as the second comparison result value 332 when the byte usage is equal to or less than the lower limit value F_{low}, and calculate ‘0’ when the byte usage is greater than the lower limit value F_{low}.

Subsequently, the resource allocation apparatus acquires a first comparison result value 331 and a second comparison result value 332 as results of the first sensing technique 321 and the second sensing technique 322, respectively, and adds the acquired plurality of comparison result values to calculate a final result value (RV) 340 for identifying the excessive bandwidth usage 350.

Subsequently, as described with reference to FIG. 6, the resource allocation apparatus compares the calculated final result value (RV) 340 with the predetermined certain reference a to check whether the excessive bandwidth usage 350 is present or not (S400).

FIG. 8 is a block diagram illustrating a configuration of an apparatus for sensing an excessive bandwidth usage according to an embodiment of the present invention.

The excessive bandwidth usage sensing apparatus may be included in a resource allocation apparatus that may allocate network resources. For example, when the resource allocation apparatus is implemented as a router, the excessive bandwidth usage sensing apparatus may be included in the router. In addition, the excessive bandwidth usage sensing apparatus may be used in conjunction with or included in another network device that may manage network traffic in addition to the router.

A configuration of the excessive bandwidth usage sensing apparatus will be described in detail with reference to FIG. 8.

The excessive bandwidth usage sensing apparatus may include a collection unit 610, a sensing unit 620, a control unit 630, and an alarm unit 640.

When the resource allocation apparatus is actually implemented as a router, the collection unit 610 may be configured as a line card and a port interface of the router and collect information on the network bandwidth usage (S100).

Subsequently, the collection unit 610 acquires information needed to identify the excessive bandwidth usage from the collected information. Here, the acquired information 310 may include the number of subscriber-based created flows, which may be used to determine a user-based byte usage and a peer-to-peer (P2P) service availability, and the information may be used to directly determine whether an excessive bandwidth is used.

The sensing unit 620 senses the excessive bandwidth usage 350 on the basis of the information 310 acquired from the collection unit 610. Here, the sensing unit 620 applies the outlier sensing technique to the acquired information 310 to sense the excessive bandwidth usage.

In addition, the sensing unit 620 may sense the excessive bandwidth usage by applying the outlier sensing technique to the acquired information 310 according to a predetermined certain period.

Subsequently, the sensing unit 620 compares a result value of the outlier sensing technique with the predetermined certain reference value α to determine the excessive bandwidth usage. Here, the sensing unit 620 determines the byte usage as the excessive bandwidth usage 350 when the result value of the outlier sensing technique is greater than the predetermined certain reference value α.

In addition, the sensing unit 620 determines the byte usage as a normal bandwidth usage 360 when the result value of the outlier sensing technique is less than the predetermined certain reference value α.

The control unit 630 limits the sensed excessive bandwidth usage 350 when the sensing unit 620 senses the excessive bandwidth usage. Here, in order to limit the excessive bandwidth usage 350, the control unit 630 may limit the excessive bandwidth usage 350 for each flow with reference to entire 5-tuple information that is collected by the collection unit 610 and limit the excessive bandwidth usage 350 for each subscriber with reference to only a source IP address (Src IP) among the 5-tuple information.

In addition, in order to limit the excessive bandwidth usage 350, the control unit 630 may use a method of discarding packets for each flow and each user, either wholly or selectively, or may use a method of blocking a creation of a new flow.

When the control unit 630 limits the excessive bandwidth usage, the alarm unit 640 transmits information on a subscriber who uses the excessive bandwidth usage 350 and detailed information on limitation of the excessive bandwidth usage 350 to an external device.

According to the excessive bandwidth usage sensing method as described above, it is possible to accurately and efficiently sense an excessive bandwidth usage for each user and limit the sensed excessive bandwidth usage by acquiring an information set of a bandwidth usage; applying a plurality of excessive bandwidth use sensing techniques to the acquired information set; and determining a presence or absence of a final excessive bandwidth usage based on a result value of each of the plurality of excessive bandwidth use sensing techniques.

While the example embodiments of the present invention and their advantages have been described in detail, it should be understood that various changes, substitutions and alterations may be made herein without departing from the scope of the invention.

What is claimed is:

1. A method of sensing an excessive bandwidth usage, the method comprising:
acquiring an information set of a bandwidth usage;
applying a plurality of excessive bandwidth use sensing techniques to the acquired information set; and
determining a presence or absence of a final excessive bandwidth usage based on a result value of each of the plurality of excessive bandwidth use sensing techniques.

2. The method of claim 1, wherein the acquiring of an information set of a bandwidth usage comprises:
acquiring a byte usage information set of the bandwidth usage; and
acquiring a subscriber-based byte usage from the acquired byte usage information set.

3. The method of claim 1, wherein the applying of a plurality of excessive bandwidth use sensing techniques comprises:
sequentially arranging the acquired information set in order of size;
sensing the excessive bandwidth usage based on a median value and a deviation value of the arranged information set to calculate a first result value using a result of the sensing; and
comparing the calculated first result value with a predetermined comparison reference value to calculate a first comparison result value.

4. The method of claim 3, wherein the comparison reference value is determined differently depending on a range for determining the bandwidth usage as the excessive bandwidth.

5. The method of claim 1, wherein the applying of a plurality of excessive bandwidth use sensing techniques comprises:
sequentially arranging the acquired information set in order of size;
dividing the arranged information set into quartiles to calculate a comparison range for sensing the excessive bandwidth usage; and
calculating a second result value according to whether the bandwidth usage is within or outside the calculated comparison range.

6. The method of claim 5, wherein the calculating of a comparison range for sensing the excessive bandwidth usage comprises determining an upper limit and a lower limit of the comparison range based on a first quartile and a third quartile among the quartiles

7. The method of claim 6, further comprising determining the bandwidth usage as the excessive bandwidth usage when the bandwidth usage is greater than or equal to the upper limit of the comparison range or less than or equal to the lower limit of the comparison range.

8. The method of claim 1, wherein the determining of a presence or absence of a final excessive bandwidth usage comprises:
adding result values of the plurality of excessive bandwidth use sensing techniques to calculate a final result value; and
comparing the calculated final result value with a predetermined threshold value to determine the excessive bandwidth usage.

9. The method of claim 8, wherein the threshold value is determined based on the number of the plurality of excessive bandwidth use sensing techniques.

10. The method of claim 9, wherein the threshold value is determined based on a half of the number of the plurality of excessive bandwidth use sensing techniques.
